(19) United States
(12) Patent Application Publication
(10) Pub. No.: US 2003/0081006 A1
(43) Pub. Date: May 1, 2003

(54) Method and system for rendering display

(76) Inventors: Mike Sheldon, Seattle, WA (US); Richard Stoakley, Seattle, WA (US); James F. Springfield, Woodinville, WA (US)

Correspondence Address: SCOTT B. STROHM, SHOOK, HARDY & BACON L.L.P., 1200 Main Street, Kansas City, MO, 64105-2118, US

(21) Appl. No.: 10/001,442

(22) Filed: Oct. 31, 2001

(51) Int. Cl. G09G 5/00

(52) U.S. Cl. 345/781; 345/788

(57) ABSTRACT

The present invention provides a method and system for use in a computer having a graphical operating system. The system and method provided is for automatically displaying a window in a maximized state on a screen when a certain resolution threshold is met. More specifically, the method involves determining a screen resolution and comparing the screen resolution to a resolution threshold. If the resolution is at or below the threshold, then the window to be opened is automatically rendered on the screen in a maximized state. If the resolution is above the threshold, the window is rendered on the screen at a specified size, or at a default size if no size is specified. In this way, the user is presented with only one active screen when the resolution is at or below the threshold, thereby simplifying navigation through multiple windows. Further, when the resolution is above the threshold, the window will not be maximized because the display would seem unpleasing to the eye of the user in a maximized state.

### STATEMENT REGARDING FEDERALLY-SPONSORED RESEARCH OR DEVELOPMENT

None.

### CROSS-REFERENCE TO RELATED APPLICATIONS

None.

### TECHNICAL FIELD

In general, the present invention relates to computer software, and more particularly, to a method and system for automatically rendering a window on a computer display screen in a maximized state when appropriate, given the display screen resolution.

### BACKGROUND OF THE INVENTION

Personal computers (PCs) such as IBM-compatible PCs typically include hardware devices such as a processor and a memory for implementing various software programs, a principal one being a central operating environment. In turn the operating environment, or operating system, supports the variety of other software applications such as a word processing program or a spreadsheet program.

Some operating systems include a graphical user interface (GUI), described generally as a graphical operating system, which displays various information to the user as a combination of pictures and text that the user can manipulate. Generally, some graphical operating systems instigate an instance of a software application by displaying the various text, graphics and features of the application within a rectangular window. One conventional method of displaying information includes the use of multiple windows drawn on a single screen for displaying outputs from, and inputs to, multiple sources at one time. Although multiple windows can arise from a single program on a computer, the typical screen includes windows from different programs executing independently of each other on the computer, or even on different computers configured to a common display.

One problem associated with multiple windows drawn on a single screen relates to a given user's ability to properly navigate from one window to another. This navigation is generally referred to as “windows management.” It has been found that for some users, it is difficult to grasp and execute the concept of windows management when multiple windows are open and drawn on a single screen, where part of one window may overlap a part of another window. In such situations, it is not always intuitive to the user as to how to navigate from one active window to another. Typically, a number of options are available to the user to switch from one window to another.

One method involves the use of the taskbar. Computer operating systems commonly use taskbars as a tool to access computer applications and their associated files in a computer system. Taskbar buttons are typically a user interface representation of running tasks and provide a simple access method for users to get to these running tasks. Typically, as applications and application files are opened, corresponding buttons appear on the taskbar. These buttons traditionally provide a link to the application file so that when a user selects the button, the application file appears on the screen. Thus, users can browse the taskbar to see the appropriate, open file they wish to view and can select the appropriate button on the taskbar in order to view that file. The taskbar button for the file or application that is active is then highlighted in some fashion, informing the user as to which file or application is currently in an active window.

Another method for switching between open applications involves the use of keystrokes. For example, on some graphical operating systems, the use of the “Alt” key in combination with the “Tab” key brings up a smaller window indicating which applications are open and running. By successively pressing the “Tab” key with the “Alt” key depressed, the open applications are highlighted and can be selected by releasing both keys. This navigational method is used most often by experienced computer users.

Another method for navigating between windows on the screen involves “clicking,” with a pointing device such as a mouse, on any inactive window that can be seen on the screen. Whenever an indication is received that a user clicked on an inactive window, the window receiving the click becomes the active window and is brought to the forefront on the display screen. In other words, there may be several open windows that can be at least partially seen on the display screen. Only one of these windows is active. A user may click on any part of an inactive window to activate the window and bring the window to the forefront, such that the entire window can be seen. However, this ability to switch simply by clicking is again not intuitive to many users. For these users, the presence of multiple windows on a single screen can be confusing.

Therefore, for these computer users, there exists a need to simplify the user experience within a graphical operating environment. In other words, there exists a need to simplify the navigational methodology used by computer users.

Another issue confronting those in the computer software industry, along with the navigational issues described above, is the display of information on the screen when operating in a graphical operating environment. In these environments, the display of content on a display screen is typically designed for the screen resolution being used by the most people. The screen resolution is the fineness of detail attained by a monitor in producing an image. For a video display, the number of pixels available is determined by the graphics mode and the video adapter, but the size of the display depends on the size and adjustment of the monitor. The resolution of a video display is taken as the total number of pixels displayed horizontally and vertically. Currently, the resolution being used by most computer users is 800 pixels by 600 pixels. With newer technologies, higher resolutions are becoming more common. For example, in display monitors known as XGA, screen resolution may be adjusted from a low of 1024 pixels by 768 pixels to a high of 1600 pixels by 1200 pixels.

At higher resolutions, the screen appears to have more “desktop” space, because objects appear smaller on the screen. Therefore, with the higher resolutions, the display image is sharper, but the icons and associated text will appear smaller and may be more difficult to clearly identify.

Therefore, when designing screen displays and content, the goal is to achieve a design that is readable and pleasing to the eye of the majority of computer users. Currently, most screen content is designed for display on screens having resolutions of 800 by 600 pixels. Therefore, when considering navigational methods, the screen resolution must also be considered, in order to display information to the user in the most pleasing and usable way possible.

### SUMMARY OF THE INVENTION

The present invention provides a method and system for use within computers having a graphical operating system. More specifically, the invention involves a system and method for automatically displaying a window in a maximized state on a screen when a certain resolution threshold is met. In the method involves determining a screen resolution and comparing the screen resolution to a resolution threshold. If the resolution is at or below the threshold, then the window to be opened is automatically rendered on the screen in a maximized state. If the resolution is above the threshold, the window is rendered on the screen at a specified size, or at a default size if no size is specified. In this way, the user is presented with only one active screen when the resolution is at or below the threshold, thereby simplifying navigation through multiple windows. Further, when the resolution is above the threshold, the window will not be maximized because the display would seem unpleasing to the eye of the user in a maximized state.

Additional advantages and novel features will be set forth in the description which follows and in part may become apparent to those skilled in the art upon examination of the following, or may be learned by practice of the invention.

### BRIEF DESCRIPTION OF THE SEVERAL VIEWS OF THE DRAWING

The present invention is described in detail below with reference to the attached drawing figures, wherein:

FIG. 1 is a block diagram of a computing system environment suitable for use in implementing the present invention;

FIG. 2 is a screen shot view of multiple windows in a non-maximized state;

FIG. 3 is a view similar to FIG. 2, showing one of the windows in a maximized state;

FIG. 4 is a view similar to FIG. 2, showing the screen in a higher resolution;

FIG. 5 is a flow chart illustrating an exemplary method of the present invention; and FIG. 6 is a flow chart illustrating another exemplary method of the present invention.

### DETAILED DESCRIPTION OF THE INVENTION

The present invention provides a system and method that allows the navigational method to be simplified among multiple, open windows while still providing a pleasing look to the user of the computer. The navigational model provides automatically maximized windows at screen resolutions at or below a predetermined threshold. This model presents one item at a time to the user, and takes advantage of the taskbar as a navigational tool. When the resolution is above the threshold, the window is not automatically maximized, so that a window having excessive blank or white space is not rendered.

Having briefly described an embodiment of the present invention, an exemplary operating environment for the present invention is described below.

Exemplary Operating Environment

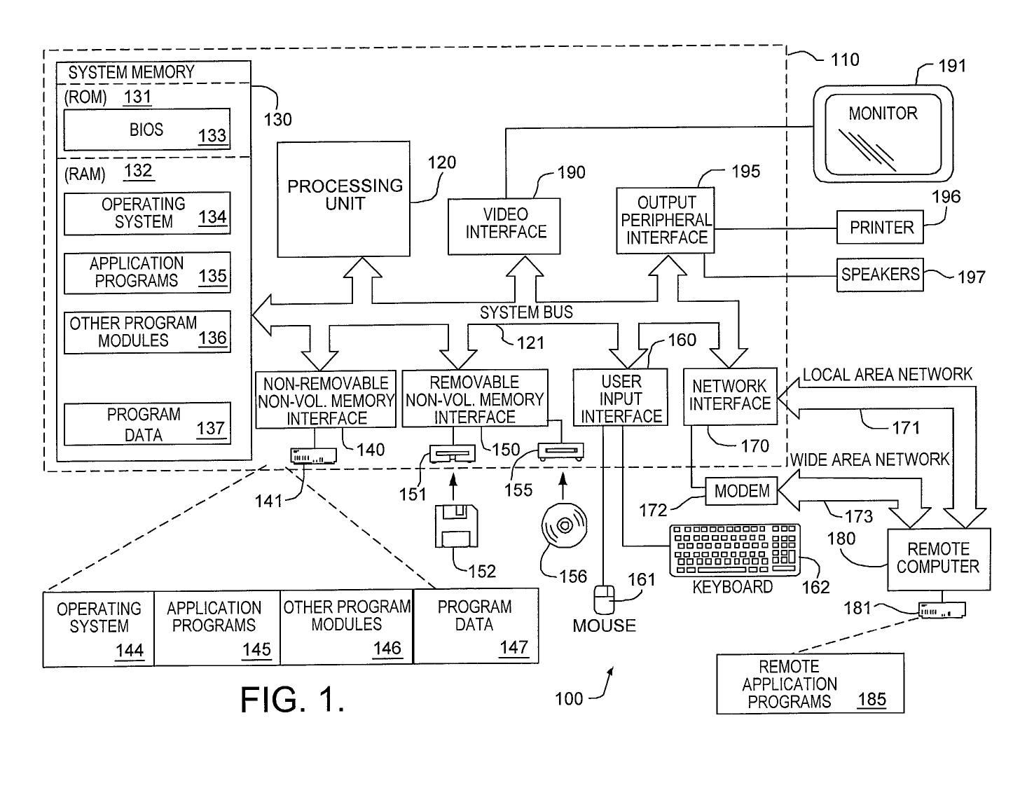

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system 100 for implementing the invention includes a general purpose computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

System for Rendering on Display Screen

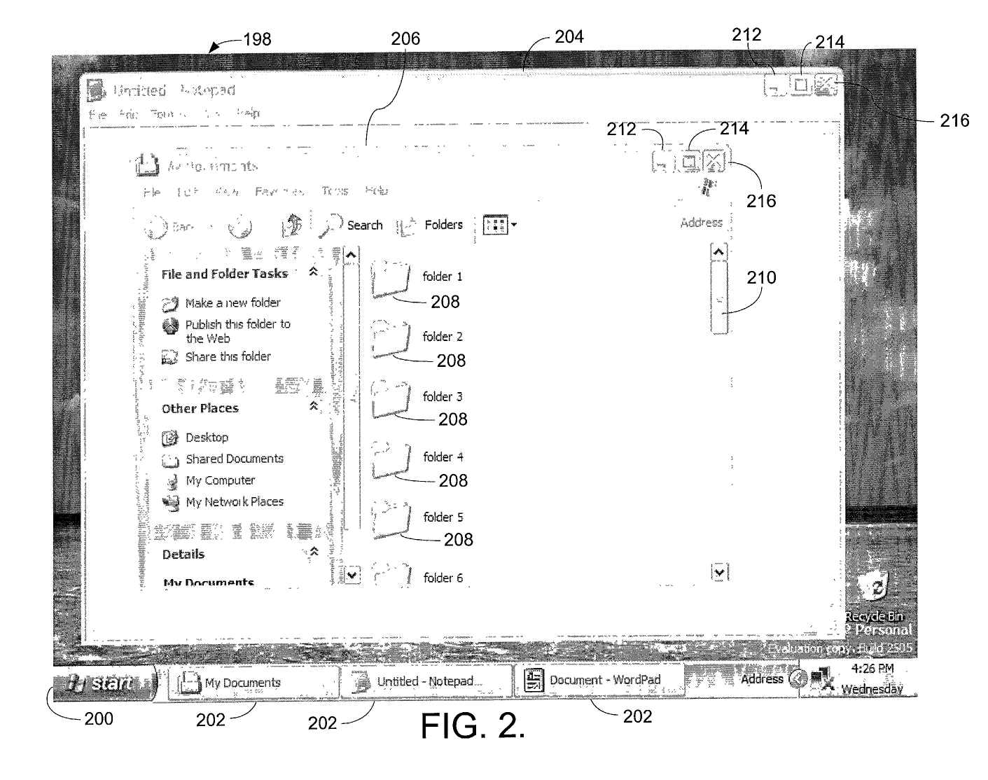

Turning now to FIGS. 2-6, a method and system for automatically rendering a maximized window will be described, as well as the conditions warranting a maximized window.

FIG. 2 is a screen shot of a computer display screen 198 illustrating the display of a graphical operating environment. In this example, the operating system is the WINDOWS XP operating system from Microsoft Corporation of Redmond, Wash. The display resolution in this case is 800 pixels by 600 pixels. In the example, the screen displays a start button 200 in the lower left-hand corner of the screen. To the right of the start button is the taskbar. As shown in this example, the taskbar has three taskbar buttons 202, indicating three different applications or files are opened. Above the task bar, the screen displays two open windows, which are again rectangular viewing areas. Window 204 is a window for an untitled word processing document. The other window, 206, overlays window 204 and is for a file and folder directory of documents. Because the screen displays more than one window, the display 198 can be confusing to the user of the computer. The user could click on the window 204 to bring that window to the forefront for processing. This action is not necessarily intuitive to the user. The user could also click on the taskbar buttons 202 to switch between open applications and files. In addition, because window 206 is not maximized on the screen, a more limited amount of information is presented. In this example, a number of folders 208 are presented, and folders 208 labeled “folder 1” though “folder 6” can be seen within the window 206. Additional folders are available within the directory, as indicated by the presence of a scrollbar 210. To view the additional folders, the scrollbar 210 must be used to “scroll down” through the directory. In the upper right-hand comer of windows 204 and 206 are three buttons. The left-most button is a minimize button 212. Clicking on this button will relegate the respective window into the taskbar, such that it is not seen on the display screen, outside of the taskbar. The middle button is a maximize button 214. Clicking on this button will maximize the display of the window to the full dimensions available on the screen. The last button is a close button 216. Clicking on the close button 216 will close the application or file.

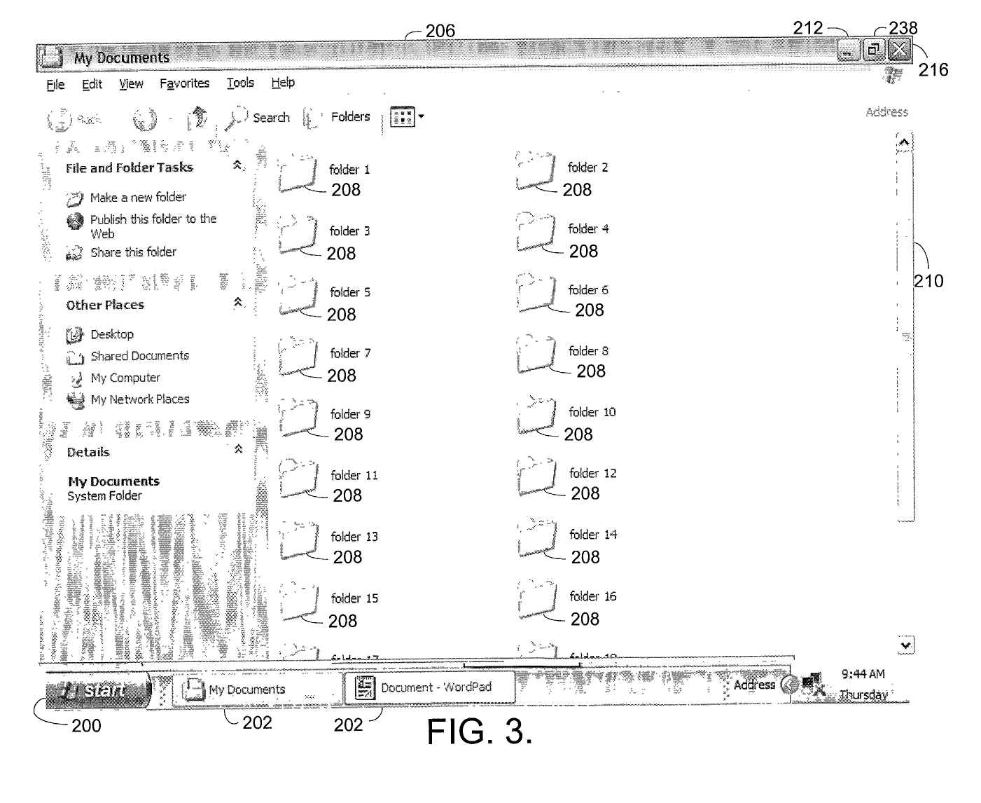

As an example, if the user clicks on button 216 associated with window 204, the window 204 closes, and will not be seen on the display screen. In addition, the taskbar button 202 associated with window 204 will no longer appear. If the user then clicks on button 214 associated with window 206, the screen will appear as shown in FIG. 3. In the display of FIG. 3, the taskbar shows two items, one of which is associated with the maximized window 206. The taskbar also evidences the closing of window 204, because the taskbar button 202 associated with it is no longer present. As shown in FIG. 3, once a window is maximized, the maximize button 214 is replaced by a restore button 238. Clicking on the restore button 238 returns the window to the size prior to maximizing. FIG. 3 also shows additional folders, above those shown in FIG. 2. In this case, by maximizing window 206, folders 208 labeled “folder 7” through “folder 16” can now be seen on the display screen without utilizing the scrollbar.

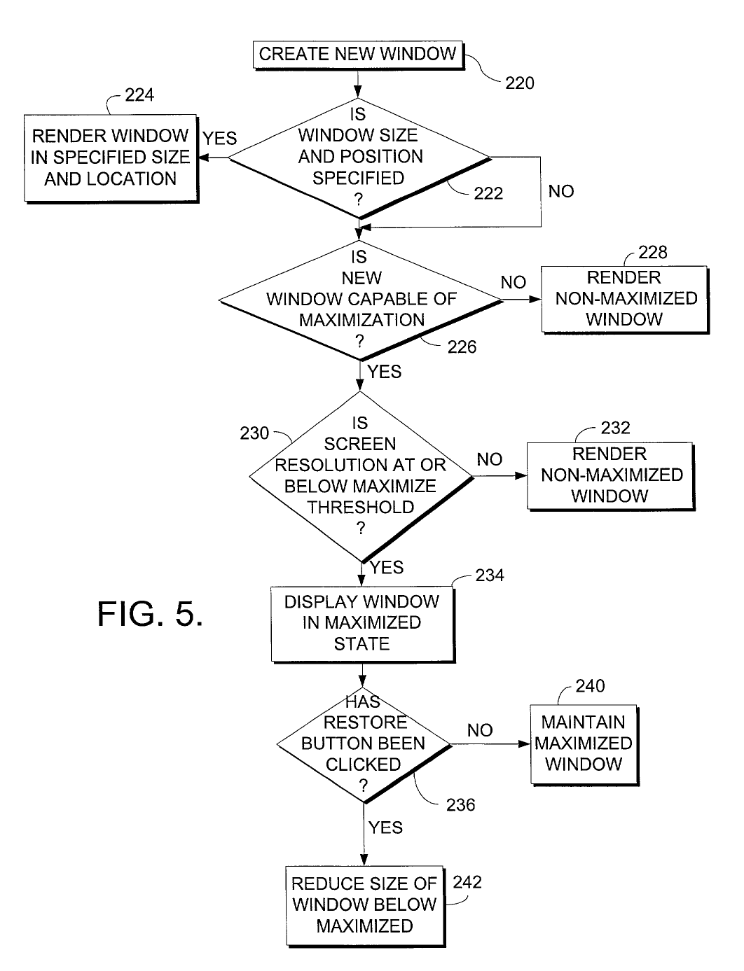

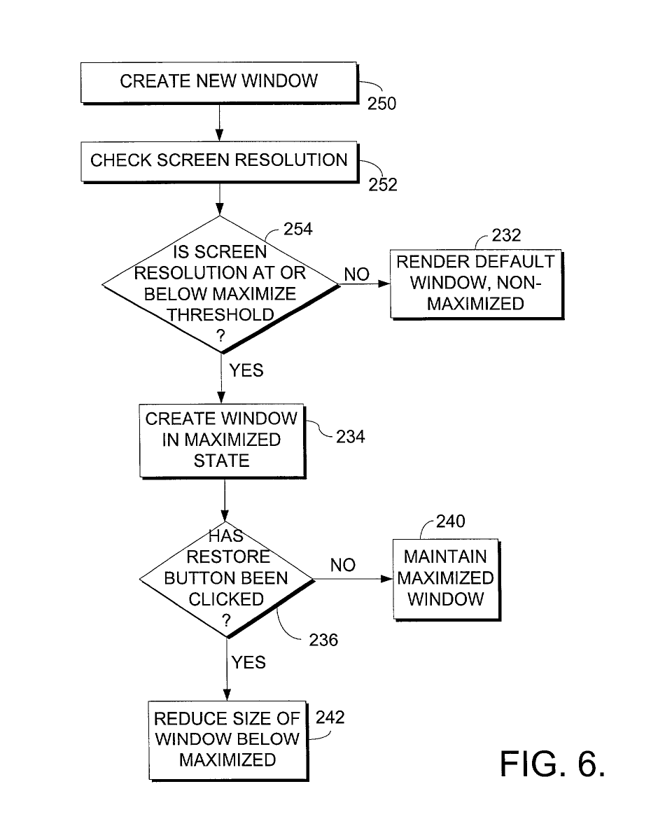

It would be desirable, in certain instances, to automatically render windows in a maximized state, such as that shown in FIG. 3. The methodology for attaining this is described below in connection with FIGS. 5 and 6.

Referring to FIG. 5, in one embodiment the method begins as a new window is created, as shown at 220. To create a window in a graphical operating environment, a special API, or application-programming interface, call is often used. Step 220 looks for instances of this call, so that each time a new window is created the methodology of FIG. 5 is executed. When it is determined that a new window is being created, it is next determined in step 222 whether a specific size and position for the window have been specified within the API call. There are instances when the author of a window desires the window to be only a certain size, and appear in a specific place on the display screen. For example, it may be desirable to display high-level system information in the center of the screen in a smaller window. If the author of a window has specified a size and position for the window, the window is drawn on the display screen at the specified size and in the specified location, as shown at 224.

If the author has not specified a size and position, or has specified only that default parameters are to be used, it is next determined if the window is one capable of maximization at step 226. Some windows are not equipped to be maximized, but are only created to be of one size. For example, some windows are created only to convey system information, such as when the computer is to be shut down. These windows are incapable of maximization. If a window is incapable of maximization, it is rendered on the screen in a non-maximized state, as shown in step 228.

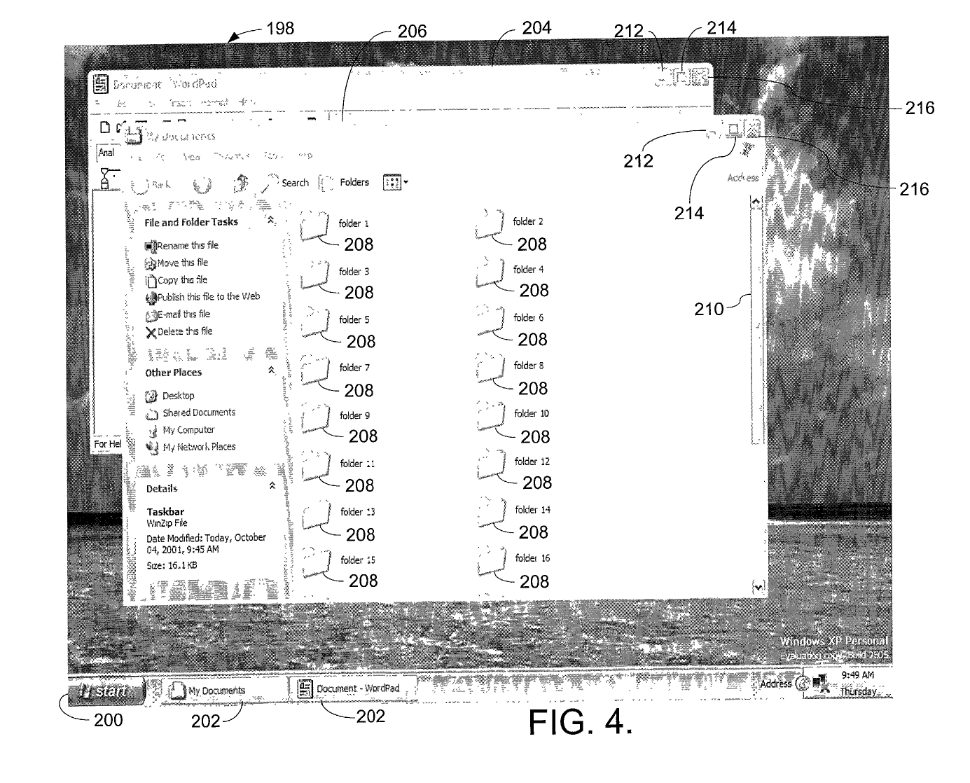

If the window is capable of maximization, the process continues at step 230 by determining if the screen resolution is at or below the predetermined maximize threshold. The threshold value can be set at different values, depending upon the prevailing technology most available at the time. As set forth above, the most widely used and available screen resolution at the present time is 800 by 600 pixels. Therefore, in one embodiment, the threshold resolution value is 800 by 600 pixels. If the resolution is above the threshold value, the window is drawn on the display screen in a non-maximized state, as shown in step 232. If, however, the screen resolution is at or below the threshold value, then the window is automatically displayed in a maximized state in step 234. The reason for the determination step 230 is primarily to achieve a balance between the desire to maximize every window (thereby making navigation easier for the user), and the desire to display the window on the screen in a size having a usable and pleasing appearance. In other words, if the screen content is designed with a screen resolution of 800 by 600 pixels, it will appear more empty and with more blank space if displayed in a maximized state on a screen with a higher resolution, such as 1024 by 768 pixels. Therefore, if the threshold value for the resolution is 800 by 600 pixels and the screen resolution is 1024 by 768 pixels, the window is rendered in a non-maximized state. As an example, FIG. 4 shows a screen shot of a display screen similar to FIG. 2, with the exception that the screen resolution is 1024 by 768 pixels. At this resolution, the screen would not appear as pleasing to the user, or be as usable, if the window were maximized. At this resolution, the content available to the user is similar to that in the maximized window of FIG. 3.

Once displayed in a maximized state in step 234, the window will appear as shown in FIG. 2. To navigate to different open applications or files, the user can click the close button 216 to completely close the maximized window. Alternatively, the user can click on a different taskbar button 202 to view the application or file associated with the taskbar button. This navigational model presents a simpler, more intuitive user interface for the user by presenting the user with only one window at a time, given the resolution threshold has not been met.

Continuing with FIG. 5, the system monitors the created window to determine, in step 236, if the restore button 238 has been clicked. When the maximized window is created in step 234, the “restored” size of the window is set. If the restore button 238 has not been clicked, the window is maintained, as shown in step 240 (and assuming that no other button has been clicked, such as the close button 216 or the minimize button 212). If, however, the restore button 238 has been clicked, the window will be reduced to the predetermined “restored” size at step 242. This portion of the process is implemented to address the problem encountered by automatically maximizing the window. When the window is automatically maximized, and a “restored” window size is not set, clicking the restore button 238 will reduce the size of the window only a minimal amount that is frequently unnoticed by users. Step 242 provides a method for reducing the size of the window by a greater, more noticeable amount, so that users are not mistakenly of the belief that the window has not changed in size.

Referring to FIG. 6, in another, slightly different, embodiment the method begins as a new window is to be created, as shown at 250. Before the window is created, the screen resolution is determined in step 252. After obtaining the screen resolution, it is next determined whether the screen resolution is at or below the predetermined threshold, at step 254. Step 254 is the same as step 230 of FIG. 5. After step 254, the process continues as described above for FIG. 5 after step 230. Steps 232 through 242 are thus labeled the same in FIGS. 5 and 6.

It can therefore been seen that the invention is well suited to address the problems noted above. Alternative embodiments of the present invention become apparent to those skilled in the art to which it pertains upon review of the specification, including the drawing figures. The various computer systems and components shown in FIGS. 1-6 and described in the specification are merely exemplary of those suitable for use in connection with the present invention. Accordingly, the scope of the present invention is defined by the appended claims rather than the foregoing description.

We claim:

1. A method in a computer system for displaying a graphical window on a display screen having a screen resolution, comprising:
determining the screen resolution for the display screen;
comparing the screen resolution against a pre-determined threshold value; and
automatically maximizing the size of the window on the display screen if the screen resolution is below the pre-determined threshold value.

2. The method of claim 1, further comprising:
determining, for the window, whether a display size and display screen position are specified for the window; and
if a size and position are specified, rendering the window at the specified size and in the specified position, so that the window is not automatically maximized.

3. The method of claim 2, further comprising:
if a size and position are not specified, determining if the window is capable of being maximized on the display screen; and
if the window is incapable of being maximized, rendering the window in a non-maximized size on the display screen, so that the window is not automatically maximized.

4. The method of claim 1, wherein the window has a restore button, the method further comprising:
determining if the restore button has been initiated; and
if the restore button has been initiated, reducing the size of the window on the display screen by a pre-determined amount.

5. The method of claim 1, wherein the predetermined threshold value is 800 pixels by 600 pixels.

6. A computer-readable medium having computer-executable instructions for performing the method recited in claim 1.

7. A computer system having a processor, a memory, and an operating environment, the computer system operable to execute the method recited in claim 1.

8. In a computer system having a graphical user interface including a display screen, a method of displaying information on the display, comprising:
creating a viewing window for the display of information on the display screen;
determining, for the window, whether a display size and display screen position are specified for the window, and if a size and position are specified, rendering the window at the specified size and in the specified position, and if not, automatically maximizing the size of the window on the display screen.

9. The method of claim 8, wherein the creating step is performed through an application programming interface call, and wherein said determining step is performed by monitoring the application programming interface call.

10. The method of claim 8, further comprising:
determining the screen resolution for the display screen;
comparing the screen resolution against a pre-determined maximize threshold value; and
automatically maximizing the size of the window on the display screen only if the screen resolution is below the pre-determined maximize threshold value.

11. The method of claim 8, wherein the window has a restore button, the method further comprising:
determining if the restore button has been initiated if the window has been maximized; and
if the restore button has been initiated, reducing the size of the window on the display screen by a pre-determined amount.

12. A computer-readable medium having computer-executable instructions for performing the method recited in claim 8.

13. A computer system having a processor, a memory, and an operating environment, the computer system operable to execute the method recited in claim 8.

14. In a computer system having a graphical user interface including a display screen, a method of displaying information on the display, comprising:
creating a viewing window for the display of information on the display screen;
determining, for the window, whether a display size and display screen position are specified for the window, and if a size and position are specified, rendering the window at the specified size and in the specified position, and if not;
determining if the window is capable of being maximized on the display screen; and
if the window is capable of being maximized, automatically rendering the window in a maximized size on the display screen.
